(19) United States
(12) Patent Application Publication
(10) Pub. No.: US 2023/0043043 A1
(43) Pub. Date: Feb. 9, 2023

(54) PORTABLE STORAGE CONTAINER

(71) Applicant: Jason Larry Schell, Lloydminster (CA)

(72) Inventor: Jason Larry Schell, Lloydminster (CA)

(21) Appl. No.: 17/444,567

(22) Filed: Aug. 6, 2021

(51) Int. Cl. B65D 88/12; B65D 90/00; B65D 90/22; G08B 13/00

(52) U.S. Cl. CPC B65D 88/12; B65D 90/0033; B65D 90/008; B65D 90/22; G08B 13/00; B65D 2590/0083; G08B 7/06

(57) ABSTRACT

A portable storage container that is constructed so as to provide a first technique and a second technique to access the interior volume. The portable storage container of the present invention includes a base platform having a housing that is superposed the base platform and operable to be removed therefrom. The base platform includes apertures that are configured to align with mounting pins of the housing. The base platform includes wheel assemblies that are configured to assist in movement of the assembled portable storage container. A pair of lifting members are secured to the top of the housing and are configured to operably engage with forklift tongues so as to provide removal of the housing from the base platform. A door is provided on one end of the housing wherein the door provides an alternate technique to access the interior volume in addition to the lifting of the housing.

### FIELD OF THE INVENTION

The present invention relates generally to storage containers, more specifically but not by way of limitation, a portable storage container configured to have an outer housing wherein the outer housing is completely removable so as to provide easier loading and unloading of objects onto the base platform of the present invention.

### BACKGROUND

As is known in the art, storage containers are utilized for various different activities. Some portable storage containers are utilized to assist people in moving wherein a container is temporarily placed in a location and loaded with items from within a residence. Ensuing the items being placed and secured in the container, the container is retrieved utilizing equipment and either transported to a new location or placed in a warehouse for subsequent retrieval thereof. In commercial applications, storage containers are often utilized to transport goods from one location to another wherein the destination location can be by way of example but not limitation, a construction site.

One issue with existing storage containers is the access to the interior volume. Conventional storage containers typically are equipped with a door on the end of the container. This door provides access to the interior volume however the access is only from a single point of entry. Many times storage containers are utilized to deliver items needed for a construction site. These items are typically installed in some type of order and as such not all of the items placed within a container may be needed at the same time. When a conventional storage container has been loaded to capacity this requires the unpacking and repacking of items that may not be needed in order to retrieve the desired item.

It is intended within the scope of the present invention to provide a storage container that provides improved access to the interior volume of the container and further includes security elements such as but not limited to geo-location tracking and alarm systems

### SUMMARY OF THE INVENTION

It is the object of the present invention to provide a portable storage container that is configured to receive and store objects therein wherein the present invention includes a base platform.

Another object of the present invention is to provide a storage container that is operable to receive items therein and is further configurable for transportation thereof wherein the base platform includes a housing superposed thereon.

A further object of the present invention is to provide a portable storage container that is configured to receive and store objects therein wherein the housing includes walls and a top that are contiguously formed so as to create the interior volume of the portable storage container when superposed the base platform.

Still another object of the present invention is to provide a storage container that is operable to receive items therein and is further configurable for transportation thereof wherein the housing is manufactured from a lightweight plastic or similar material and further includes integrated lifting members on the top.

An additional object of the present invention is to provide a portable storage container that is configured to receive and store objects therein wherein the end wall of the housing further includes an overhead style access door.

Yet a further object of the present invention is to provide a storage container that is operable to receive items therein and is further configurable for transportation thereof wherein the base platform includes wheels secured to ends thereof.

Another object of the present invention is to a provide a portable storage container that is configured to receive and store objects therein wherein the housing includes mounting pegs extending downward from the lower perimeter thereof that are operable to be inserted into mating apertures on the upper surface of the base platform.

An alternate object of the present invention is to provide a storage container that is operable to receive items therein and is further configurable for transportation thereof wherein the present invention includes security items such as but not limited to geo-location tracking, video surveillance and an alarm system.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention with the housing removed from the base member; and

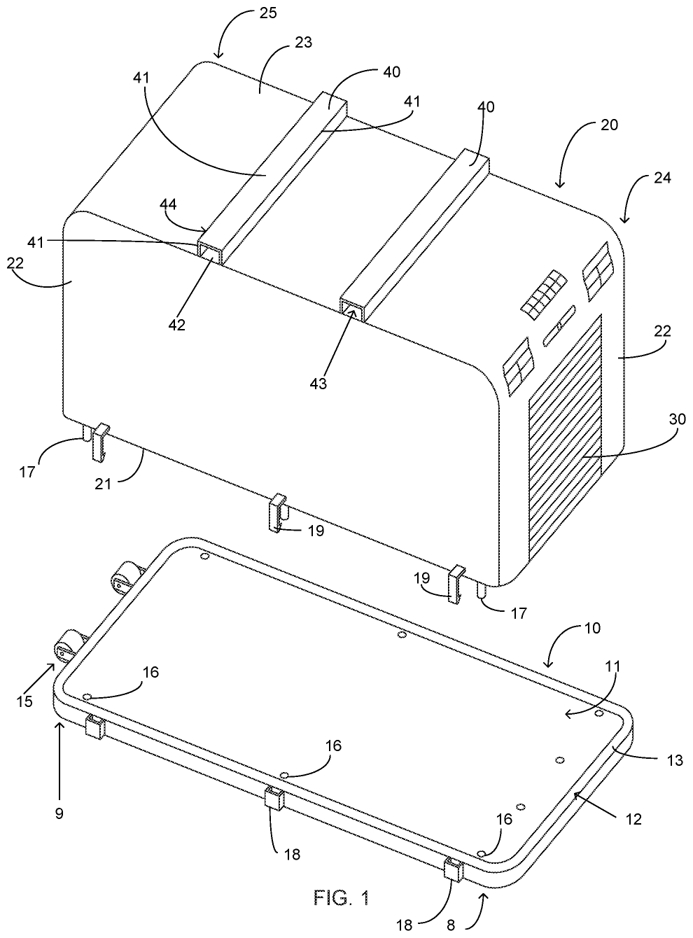

FIG. 2 is a perspective view of the present invention with the housing secured to the base member.

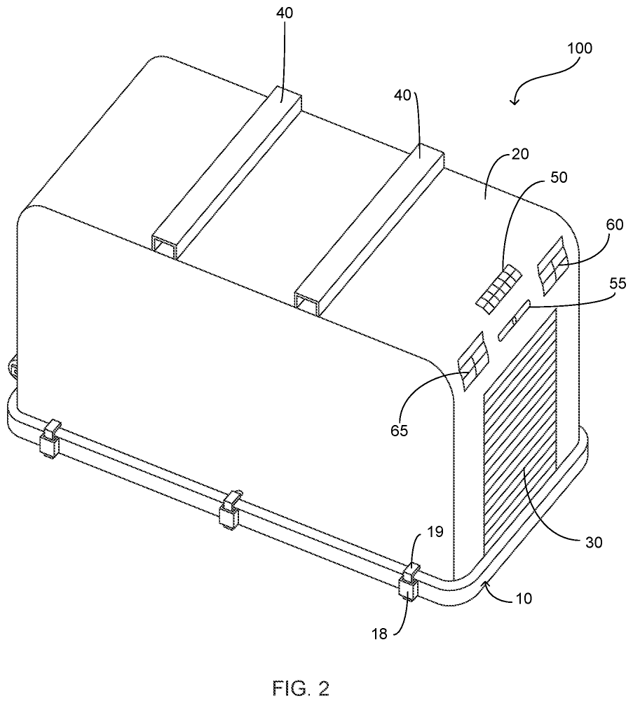

### DETAILED DESCRIPTION

Referring now to the drawings submitted herewith, wherein various elements depicted therein are not necessarily drawn to scale and wherein through the views and figures like elements are referenced with identical reference numerals, there is illustrated a portable storage container 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted as a part hereof, the portable storage container 100 includes a base platform 10 and a housing 20 wherein the housing 20 is releasably secured to the base platform 10. The releasable securing of the base platform 10 and housing 20 provides a first access technique and a second access technique to the interior volume of the portable storage container 100 as will be further discussed herein. The base platform 10 is manufactured from a suitable rigid material such as but not limited to metal. The base platform 10 is planar in manner having an upper surface 11 and an outer perimeter edge 12 wherein the outer perimeter edge 12 defines the shape of the base platform 10. While the base platform 10 is illustrated herein as being rectangular in shape, it should be understood within the scope of the present invention that the base platform 10 could be provided in alternate shapes and sizes. The base platform 10 has secured to the second end 9 thereof wheel assemblies 15. Wheel assemblies 15 are provided to assist in moving the portable storage container 100 wherein the first end 8 can be lifted with equipment such as but not limited to a forklift and rolled to a desired position utilizing wheel assemblies 15. Additionally, the wheel assemblies 15 are utilized when the portable storage container 100 is deposited at a location wherein the portable storage container 100 is transported on a flatbed truck and removed therefrom to be left in a desired location. It is contemplated within the scope of the present invention that the portable storage container 100 could have more or less than two wheel assemblies 15 in order to achieve the desired objective. Furthermore, it is contemplated within the scope of the present invention that the wheel assemblies 15 could be present on either end of sides of the portable storage container 100. It is contemplated within the scope of the present invention that the portable storage container 100 could be provided in a size ranging from ten feet to thirty-two feet in length.

The base platform 10 includes apertures 16 formed in the upper surface 11. The apertures 16 are formed in the base platform 10 utilizing suitable techniques and are positioned so as to align with and have inserted thereinto mounting pins 17. Mounting pins 17 are secured to the bottom edge 21 of the housing 20 and extend downward therefrom. The mounting pins 17 are manufactured from a rigid material and function to engage the apertures 16 so as to ensure proper alignment of the housing 20 and the base platform 10 when being placed together. It should be understood within the scope of the present invention that the base platform 10 could have therein various quantities of apertures 16 so as to mateably couple with the same quantity of mounting pins. The base platform 10 has secured to the perimeter edge 12 couplings 18. Couplings 18 are configured to mateably secured to couplings 19 so as to releasably secure the housing 20 to the base platform 10. It is contemplated within the scope of the present invention that the portable storage container 100 could employ alternate types of couplings and be equipped with various quantities thereof. A sealing member 13 is present on the outer perimeter edge 12. The sealing member 13 is manufactured from rubber or other similar material and is operable to ensure a weatherproof seal between the housing 20 and the base platform 10 when operably coupled.

The housing 20 includes a plurality of walls 22 and a top 23 being integrally formed to create an interior volume. The walls 22 and top 23 in a preferred embodiment are manufactured from a lightweight rigid material such as but not limited to recycled plastic. The housing 20 includes a first end 24 and second end 25 wherein the first end 24 has a door 30. The door 30 provides a first technique to access the interior volume of the portable storage container 100. In a preferred embodiment the door 30 is an overhead style door but it is contemplated within the scope of the present invention that the door 30 could be alternate styles of doors. Furthermore, it is contemplated within the scope of the present invention that the portable storage container 100 could employ more than one door located in alternate positions on the housing 20.

Secured to the top 23 of the housing 20 are lifting members 40. The lifting members 40 are secured utilizing suitable techniques and are mounted so as to extend across the width of the top 23. The lifting members 40 include three walls 41 forming an interior volume 42 having an opening 43 at the first end 44. The opening 43 is sufficient in size so as to receive a forklift tongue therein. The lifting members 40 are placed centrally on the top 23 and spaced apart so as to facilitate mateable engagement with a forklift. The lifting members 40 receive forklift tongues into the interior volume 42 wherein the housing 20 is subsequently lifted from the base platform 10 so as to provide access to any item that has been stored within the portable storage container 100. This provides a second technique of accessing the interior volume of the portable storage container 100. While the lifting members 40 are illustrated and discussed herein as being configured to engage forklift tongues, it is contemplated within the scope of the present invention that the lifting members 40 could be alternately constructed so as to be engaged with other types of equipment so as to lift the housing 20 from the base platform 10. Furthermore, it is contemplated within the scope of the present invention that the portable storage container 100 could have alternate quantities of lifting members 40.

Secured to the housing 20 are a controller 50, lights 55, geo-location unit 60 and alarm module 65. The controller 50 includes the necessary electronics to receive, store, transmit and manipulate data. The controller 50 provides operation of the lights 55, geo-location unit 60 and alarm module 65 and further is operable to transmit various data to a remote operator of the portable storage container 100. The alarm module 65 functions to provide audio and visual alert to unauthorized access to the portable storage container 100. Additionally, the controller 50 provides notification to a remote user in the even the alarm module 65 is activated. The lights 55 are conventional lights and are also contemplated to be within the interior volume of the portable storage container 100. The geo-location unit 60 is a standard geo-location tracking element that is operable to allow a user to identify the geographic location of the portable storage container 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A portable storage container comprising:
a base platform, said base platform being planar in manner, said base platform having an upper surface, said base platform having at least one aperture formed in the upper surface, said base platform having a first end and a second end;
a housing, said housing having a plurality of walls and a top being integrally formed, said housing being configured to be releasably secured to said base platform, said housing having a first end and a second end; and
at least one lifting member, said at least one lifting member being secured to said top of said housing, said at least one lifting member configured to provide an element so as to lift said housing from said base platform.

2. The portable storage container as recited in claim 1, wherein said housing further includes at least one mounting pin, said at least one mounting pin configured to align with and be inserted into said at least one aperture of said base platform during coupling of said housing to said base platform.

3. The portable storage container as recited in claim 2, and further including at least one coupling, said at least one coupling having a first portion and a second portion, said first portion being located on a perimeter edge of said base platform, said second portion being located on a bottom edge of said housing, said at least one coupling configured to releasably secure said housing to said base platform.

4. The portable storage container as recited in claim 3, and further including at least one door, said at least one door being located in a wall of said housing.

5. The portable storage container as recited in claim 4, and further including a wheel assembly, said wheel assembly mounted to said base platform on said second end thereof.

6. The portable storage container as recited in claim 5, and further including a controller, said controller having electronics operable to receive, store, transmit and manipulate data.

7. The portable storage container as recited in claim 6, and further including an alarm module, said alarm module being operably coupled to said controller, said alarm module configured to provide notification of unauthorized access to the portable storage container.

8. The portable storage container as recited in claim 7, and further including a geo-location unit, said geo-location unit configured to provide the geographic location of the portable storage container.

9. The portable storage container as recited in claim 8 wherein the housing is manufactured from recycled plastic.

10. A portable storage container that is constructed to provide a first technique and a second technique of accessing an interior volume thereof wherein the portable storage container comprises:
a base platform, said base platform being planar in manner, said base platform having an upper surface, said base platform having a plurality of apertures formed in the upper surface, said base platform having a first end and a second end, said base platform having an outer perimeter edge wherein said outer perimeter edge has a sealing member present thereon;
a housing, said housing having a plurality of walls and a top being integrally formed, said housing being configured to be releasably secured to said base platform, said housing having a first end and a second end, said housing having a door formed in said first end, said housing having a lower edge, said housing having a plurality of mounting pins proximate said lower edge wherein said plurality of mounting pins are operable to engage said plurality of apertures when said housing is superposed said base platform; and
two lifting members, said two lifting members being secured to said top of said housing, said two lifting members being mounted between opposing sides of the top and extending substantially therebetween, said two lifting members configured to have forklift tongues inserted therein.

11. The portable storage container as recited in claim 10, wherein said two lifting members each include three walls forming an interior volume, said two lifting members having an opening at a first end thereof.

12. The portable storage container as recited in claim 11, and further including a plurality of couplings, said plurality of couplings having a first portion and a second portion, said first portion being located on the outer perimeter edge of said base platform, said second portion being located on the lower edge of said housing, said plurality of couplings configured to releasably secure said housing to said base platform.

13. The portable storage container as recited in claim 12, and further including two wheel assemblies, said two wheel assemblies being secured to said second end of said base platform.

14. The portable storage container as recited in claim 13, and further including a controller, said controller having electronics operable to receive, store, transmit and manipulate data.

15. The portable storage container as recited in claim 14, and further including a geo-location unit, said geo-location unit configured to provide the geographic location of the portable storage container.

16. The portable storage container as recited in claim 15, and further including an alarm module, said alarm module being operably coupled to said controller, said alarm module configured to provide notification of unauthorized access to the portable storage container.

17. The portable storage container as recited in claim 16, wherein said housing is manufactured from recycled plastic.
